(19) United States
(12) Patent Application Publication
(10) Pub. No.: US 2020/0021123 A1
(43) Pub. Date: Jan. 16, 2020

(54) Charger

(71) Applicant: InvenTel Products, LLC, Rockaway, NJ (US)

(72) Inventors: Yasir Abdul, Kinnelon, NJ (US); Brandon Solotoff, Mt. Arlington, NJ (US)

(73) Assignee: InvenTel Products, LLC, Rockaway, NJ (US)

(21) Appl. No.: 16/350,978

(22) Filed: Feb. 7, 2019

Related U.S. Application Data
(60) Provisional application No. 62/627,465, filed on Feb. 7, 2018.

(51) Int. Cl. H02J 7/00; H02J 50/10

(52) U.S. Cl. CPC H02J 7/0045; B60L 1/006; H02J 50/10

(57) ABSTRACT

A charger capable of charging and supporting various electronic devices both through direct wired charging and through wireless inductive charging. The charger utilizes a flexible and positionable gooseneck cable to support electronic devices while charging in various useful positions.

### PRIORITY CLAIM

The present application claims the benefit of priority to U.S. provision application 62/627,465 entitled “Charger” filed in the U.S. Patent & Trademark Office on Feb. 7, 2018, the entirety of which is incorporated by reference herein.

### FIELD OF THE INVENTION

The present invention relates generally to a charger, and more particularly to a multifunctional flexible charger, dock, stand and syncing station for use wirelessly and non-wirelessly charging electronic devices.

### BRIEF DESCRIPTION OF THE DRAWINGS

FIG. 1 is a front top perspective view of a charger for mounting an electronic device thereon showing a first embodiment of the new invention;

FIG. 2 is a rear top perspective view thereof;

FIG. 3 is a front view thereof;

FIG. 4 is a rear view thereof;

FIG. 5 is a left side elevation view thereof;

FIG. 6 is a right side elevation view thereof;

FIG. 7 is a top view thereof;

FIG. 8 is a bottom view thereof;

FIG. 9 is a front top perspective view of a charger for mounting an electronic device thereon showing a second embodiment of the new invention;

FIG. 10 is a rear top perspective view thereof;

FIG. 11 is a front view thereof;

FIG. 12 is a rear view thereof;

FIG. 13 is a left side elevation view thereof;

FIG. 14 is a light side elevation view thereof;

FIG. 15 is a top view thereof;

FIG. 16 is a bottom view thereof;

FIG. 17 depict a docking head in accordance with an illustrative embodiment of the invention;

FIGS. 18-19 are photographs showing the present invention;

FIGS. 20-24 show the product and packaging; and

FIG. 25 shows an alternative embodiment of the docking head of the invention.

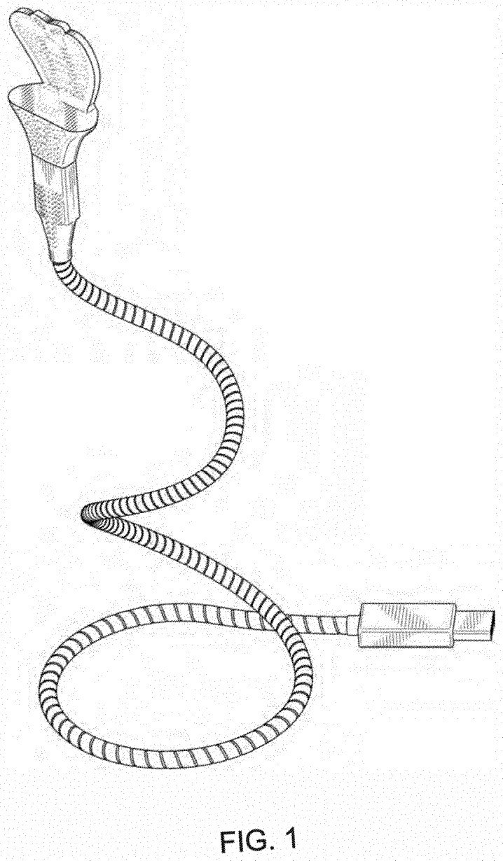

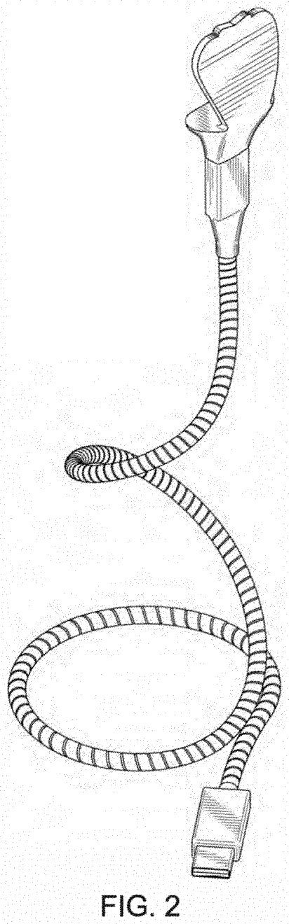

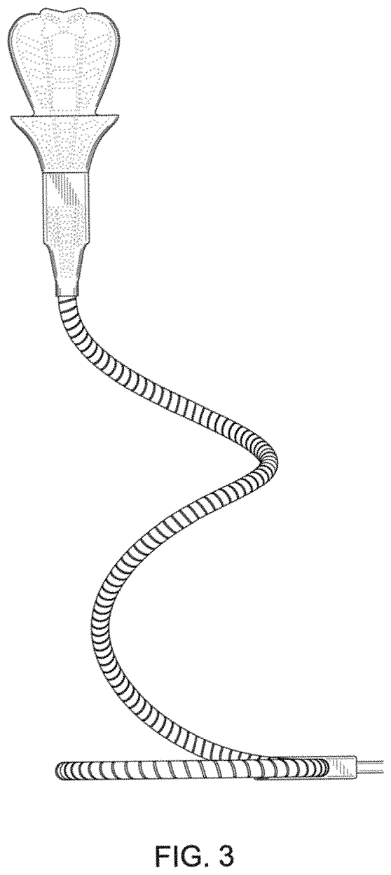

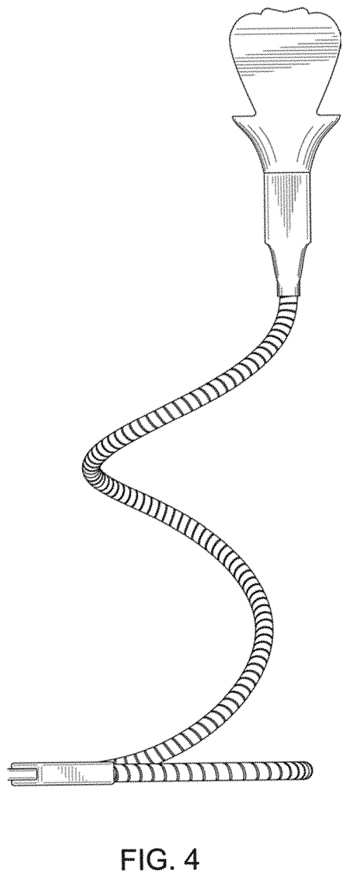

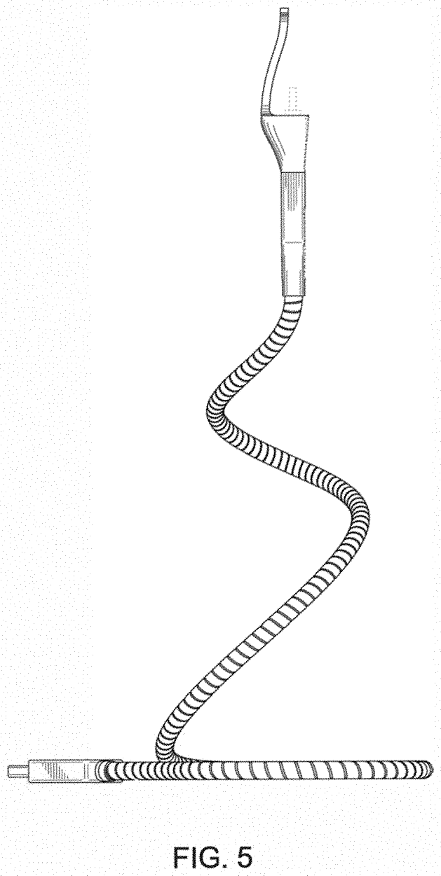

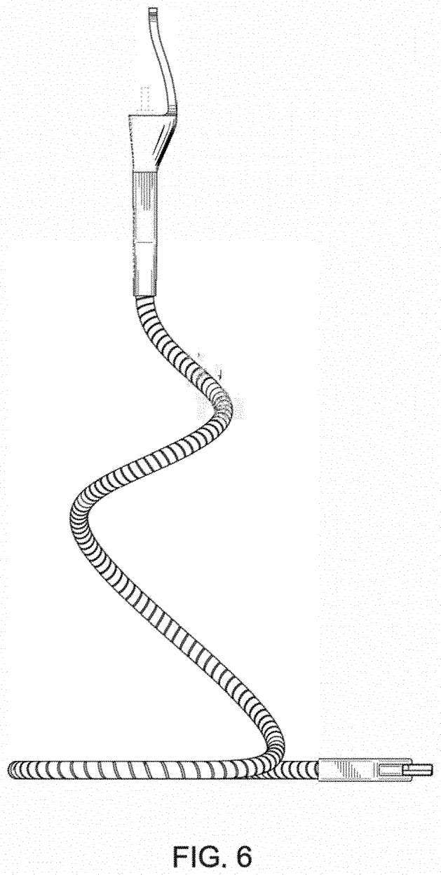

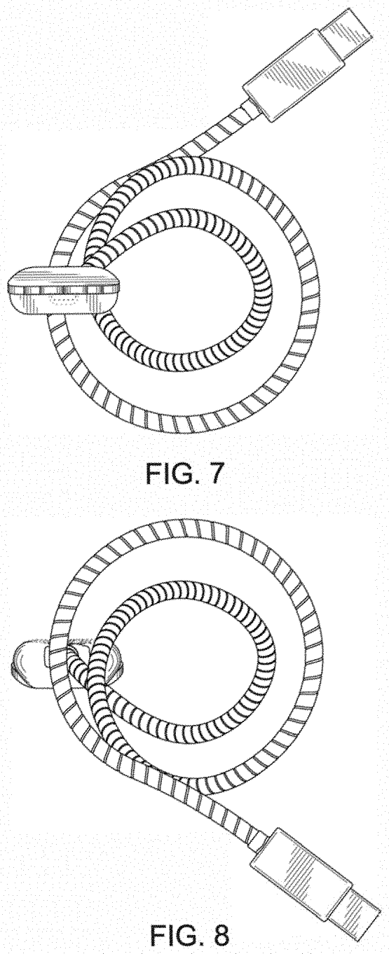

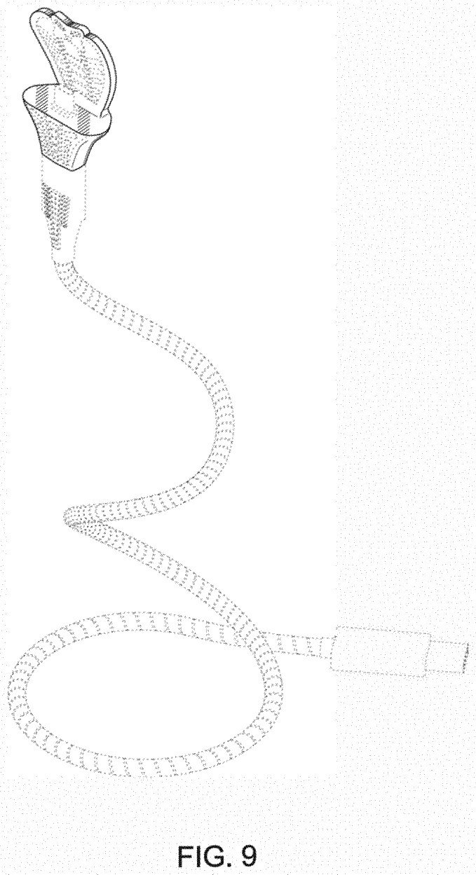

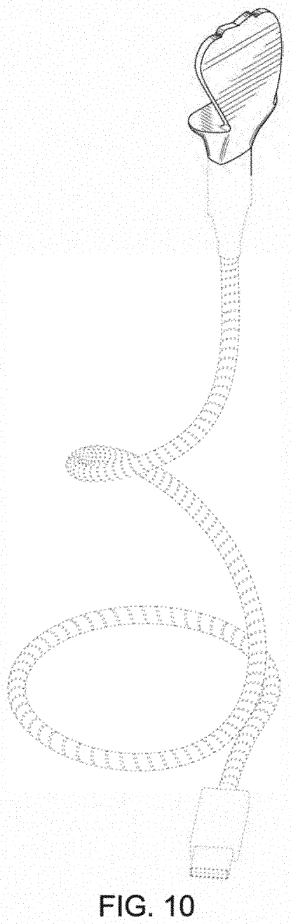

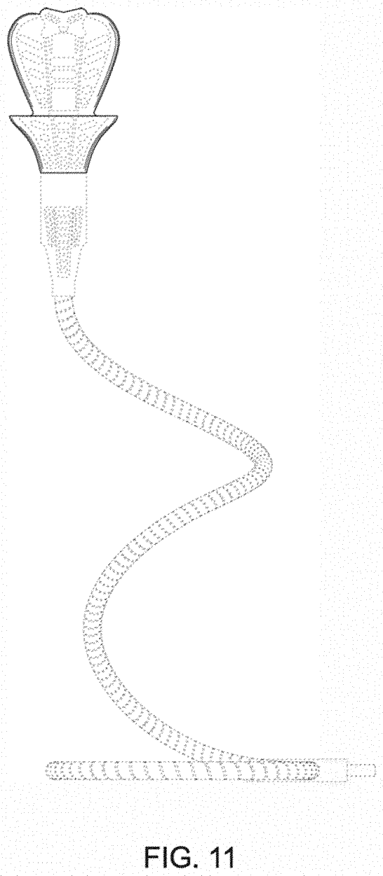

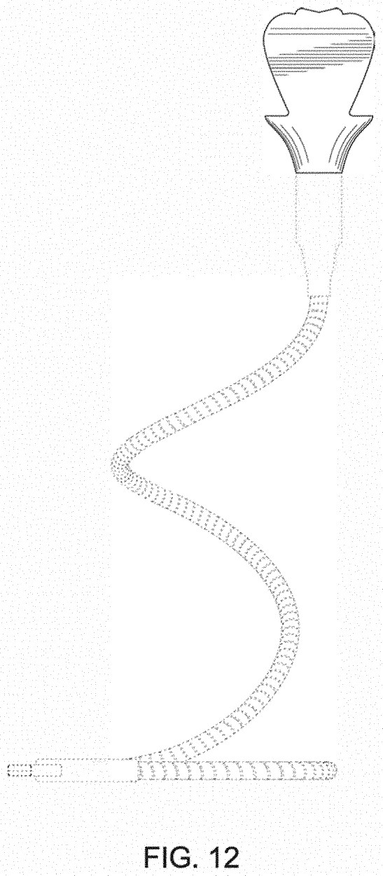

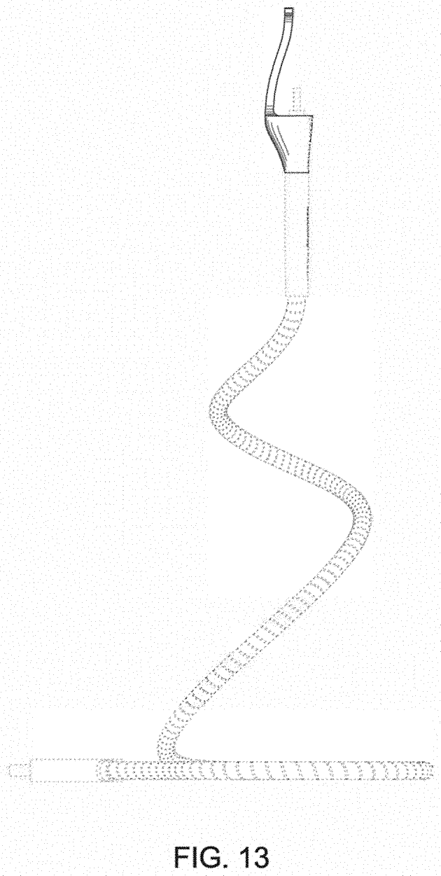

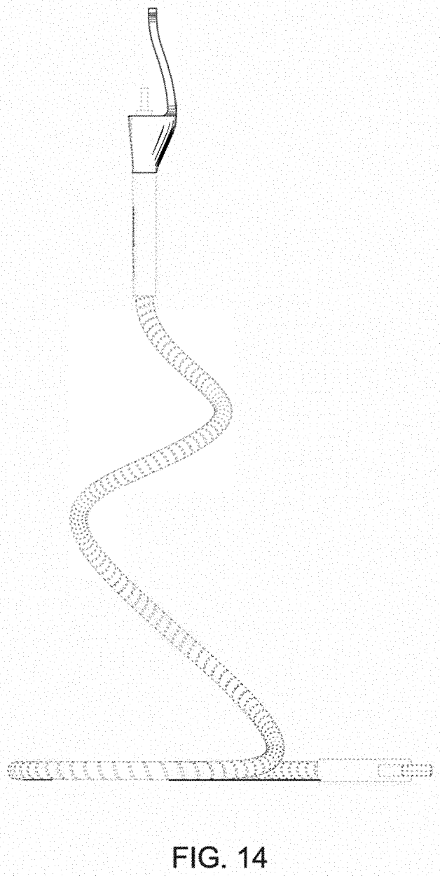

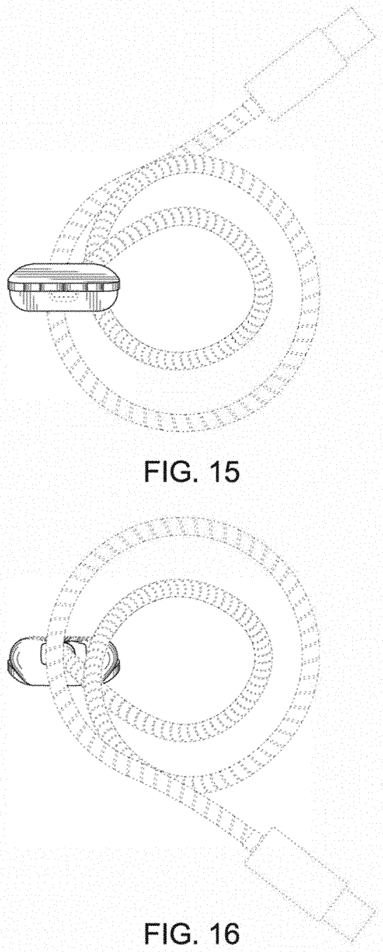

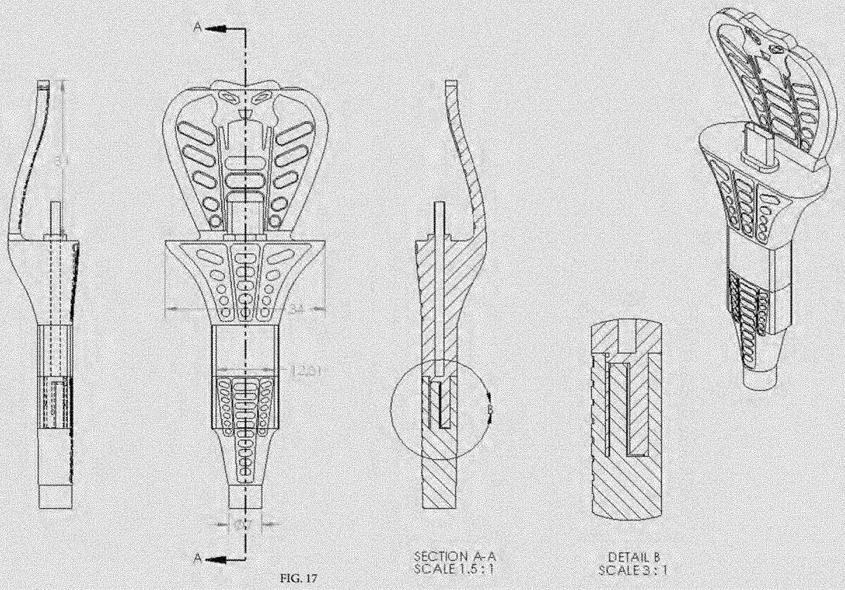

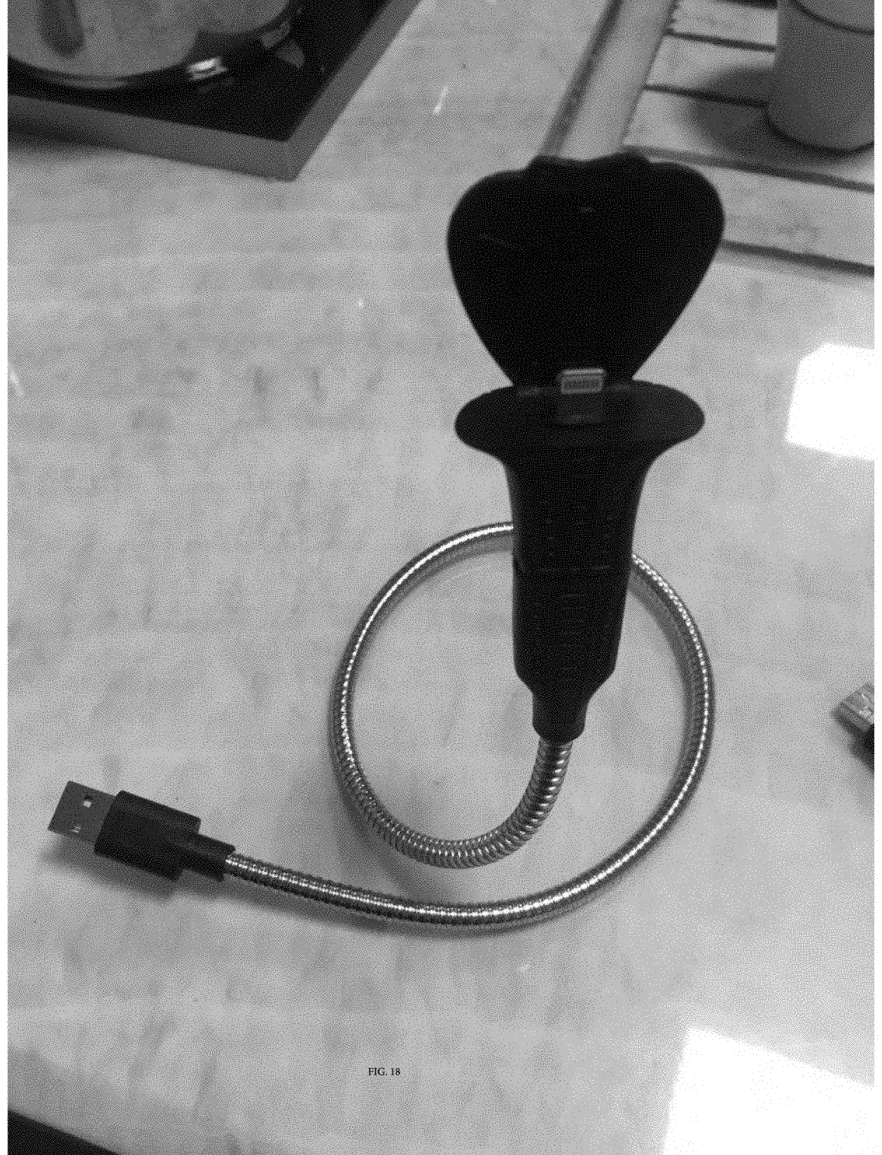

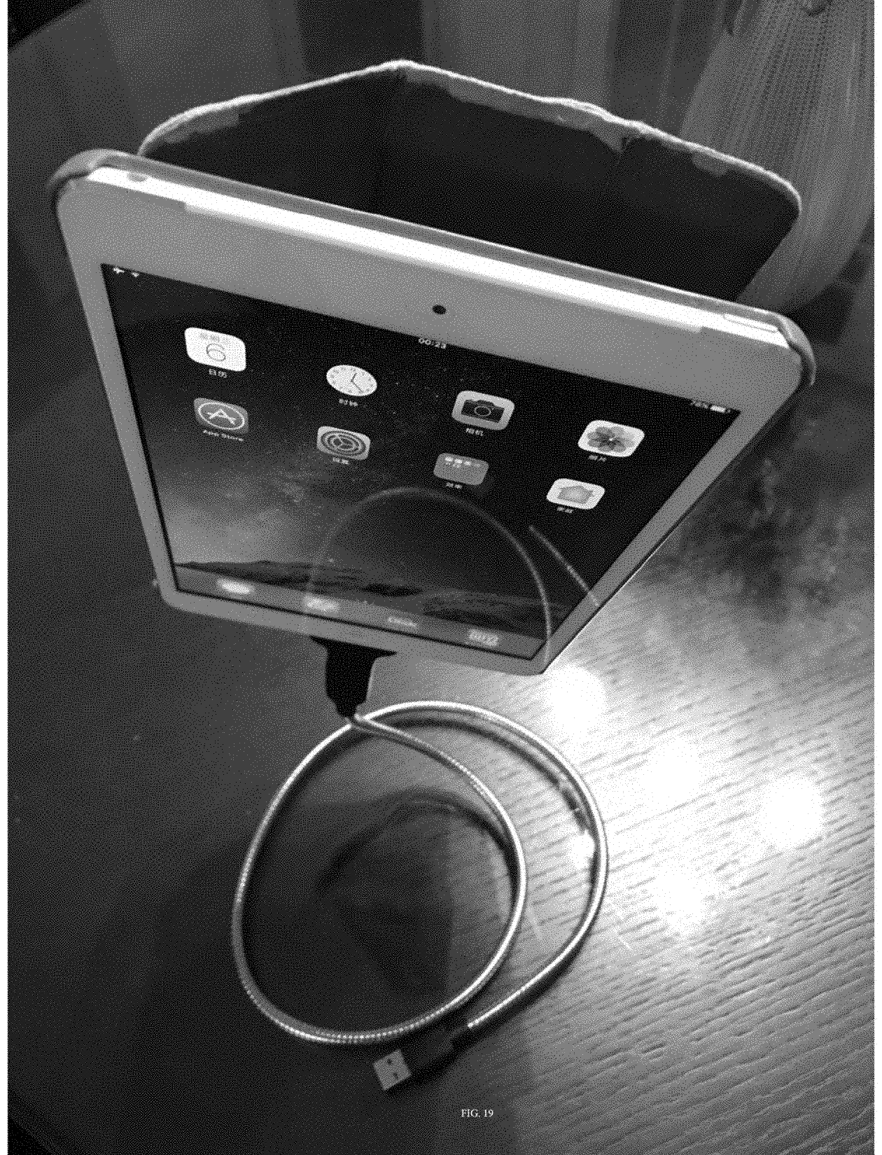

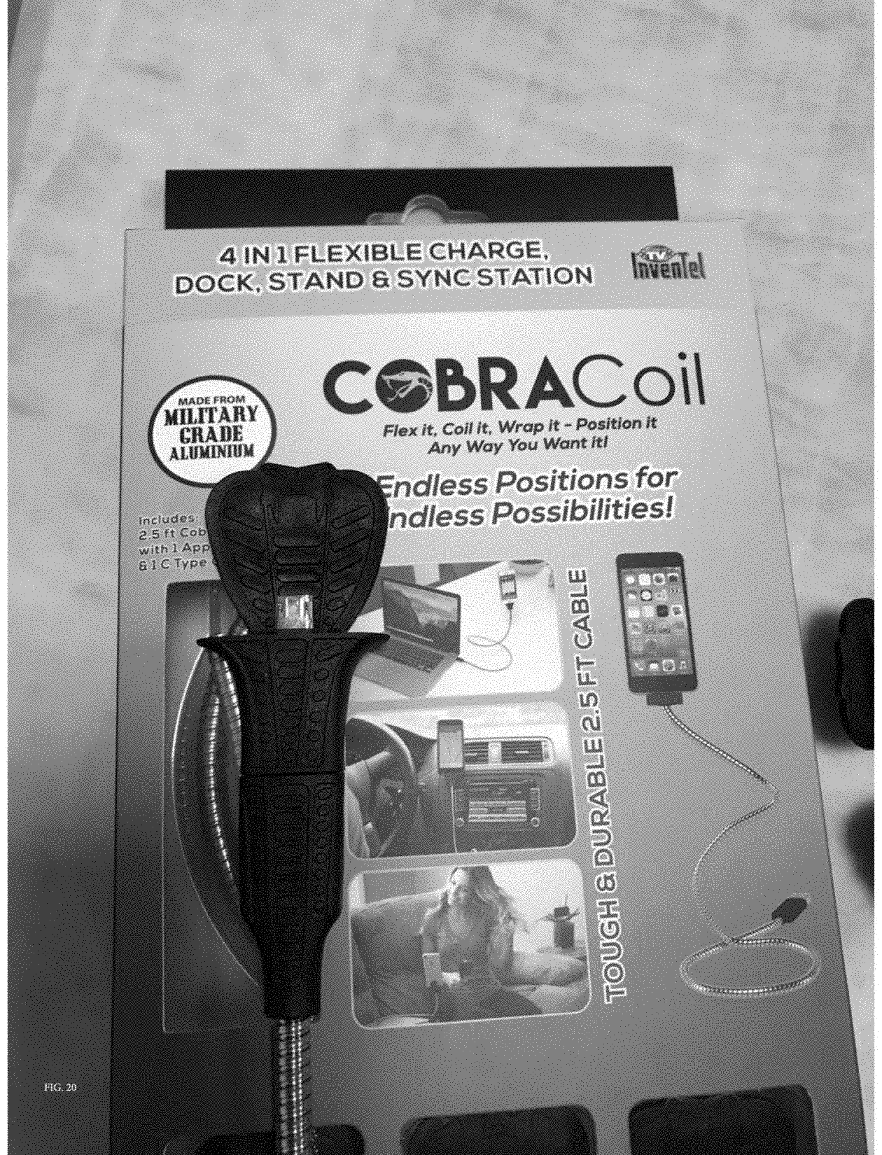

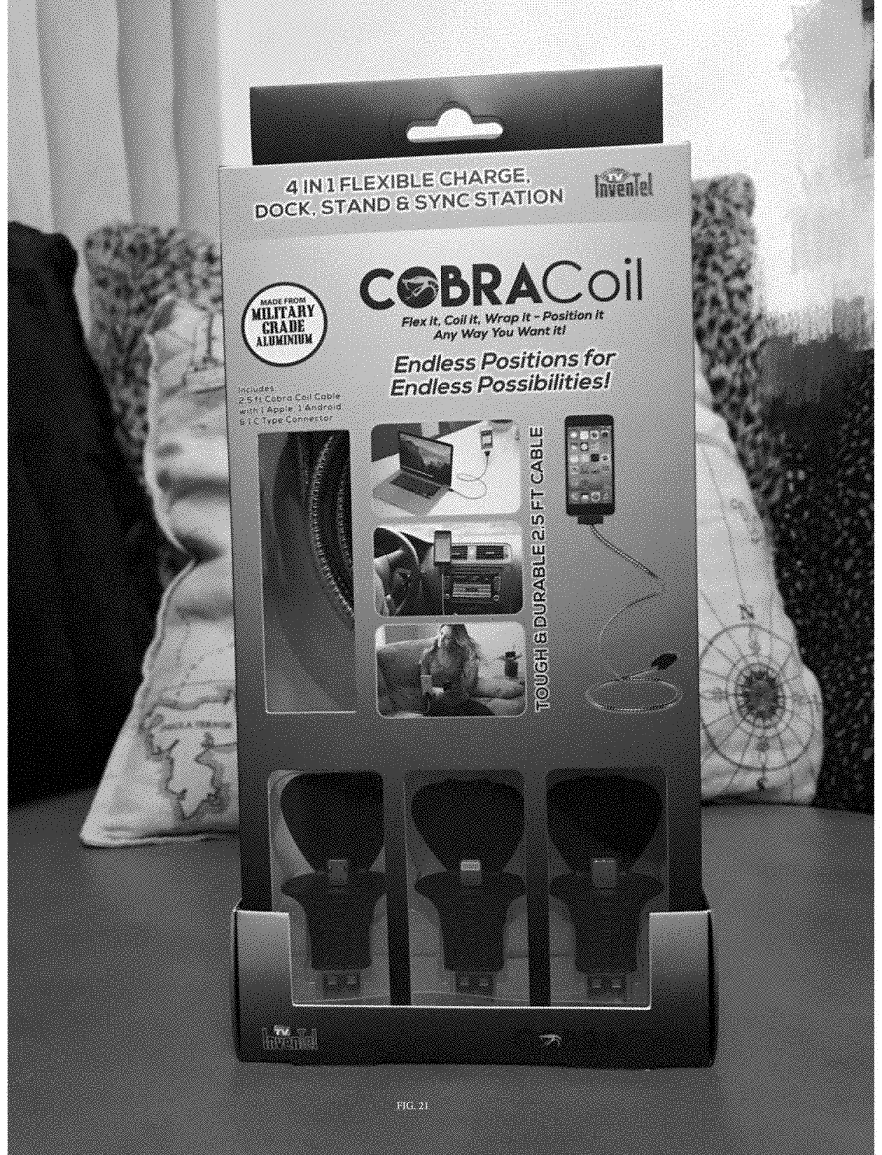

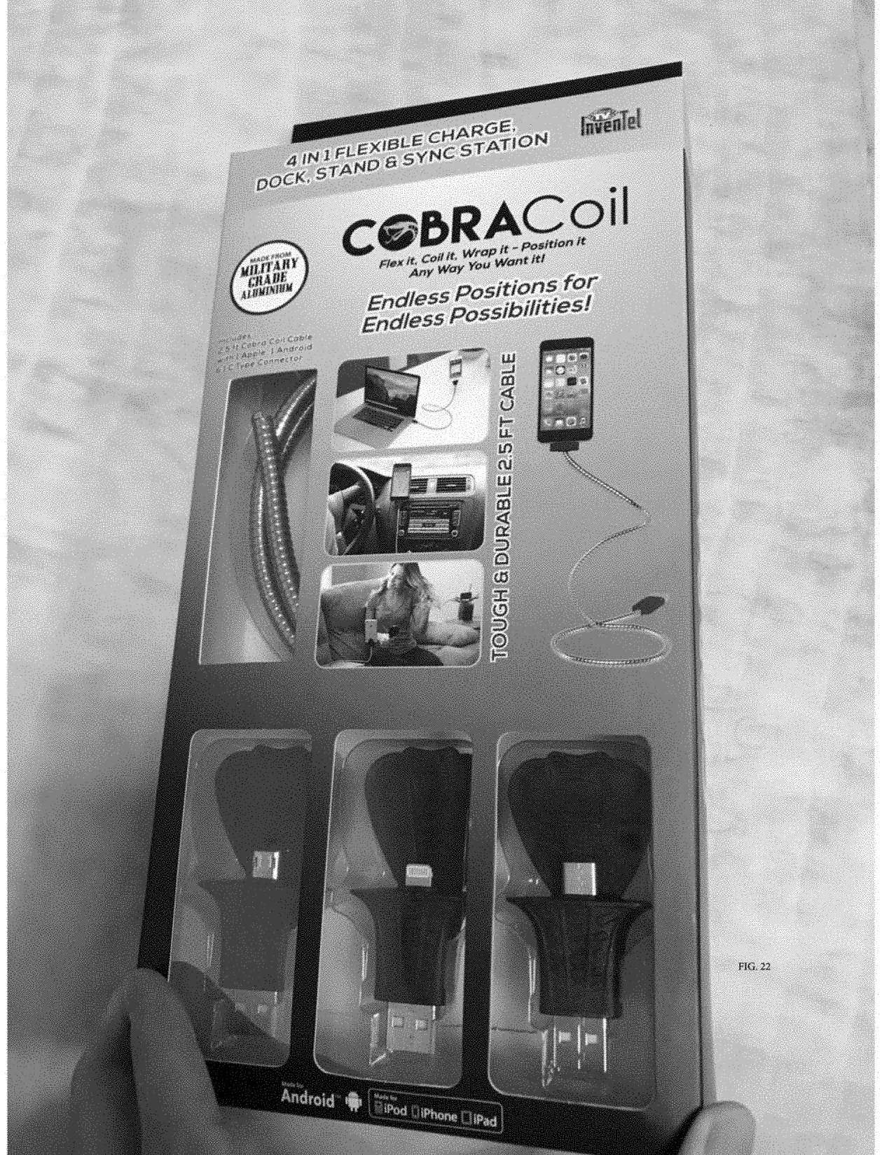

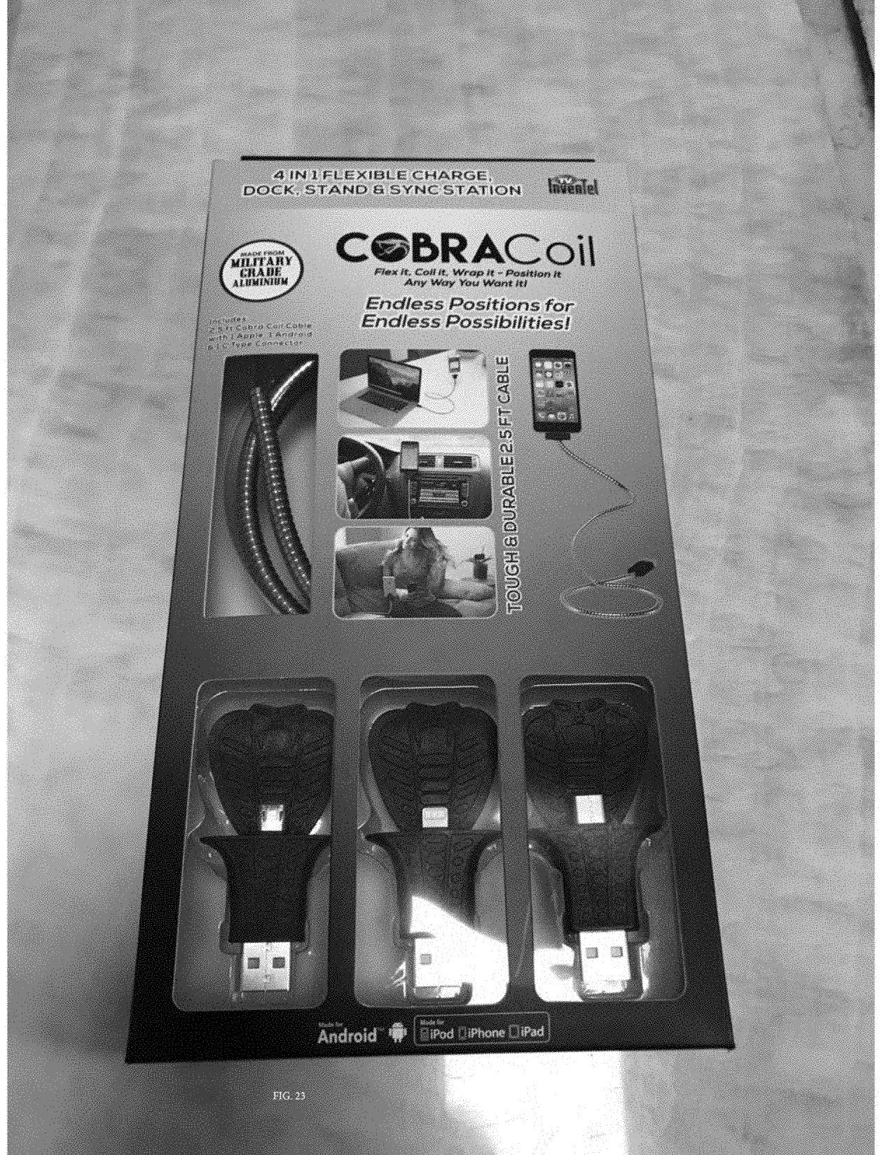

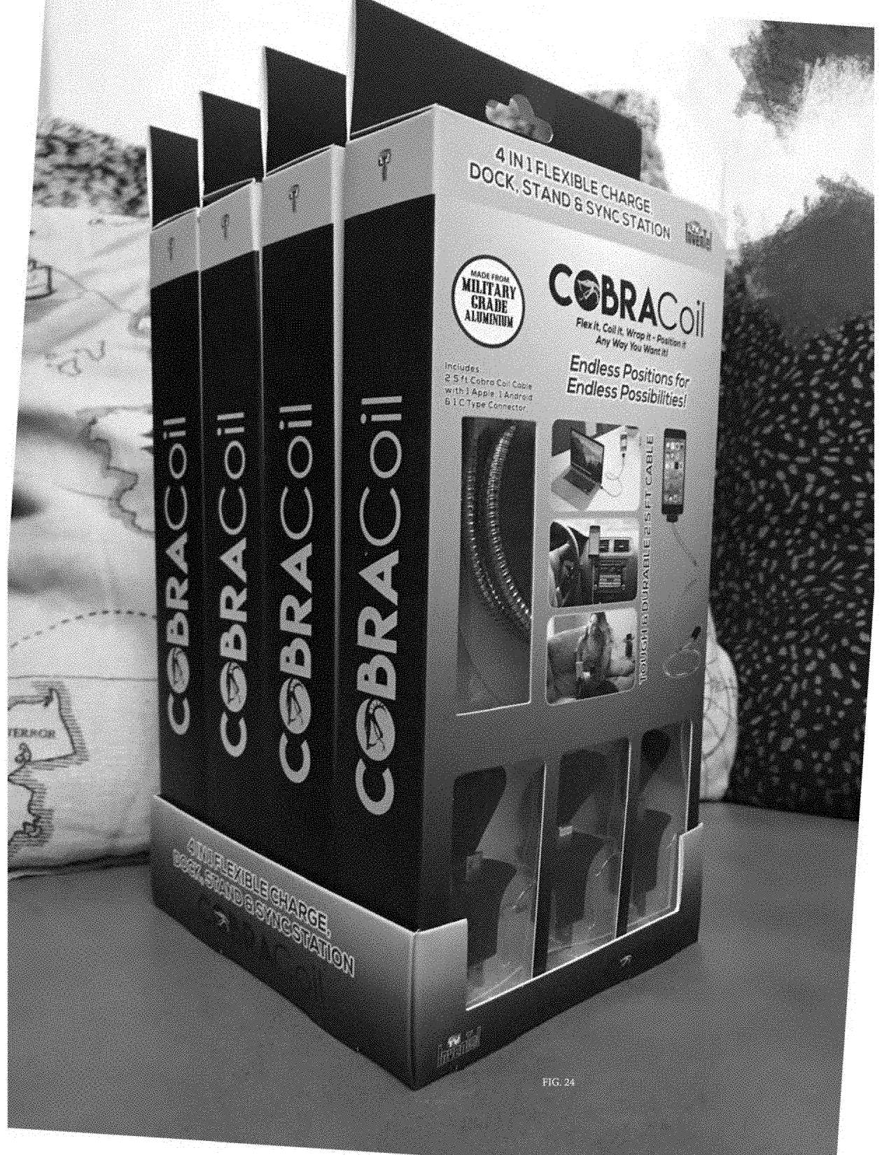

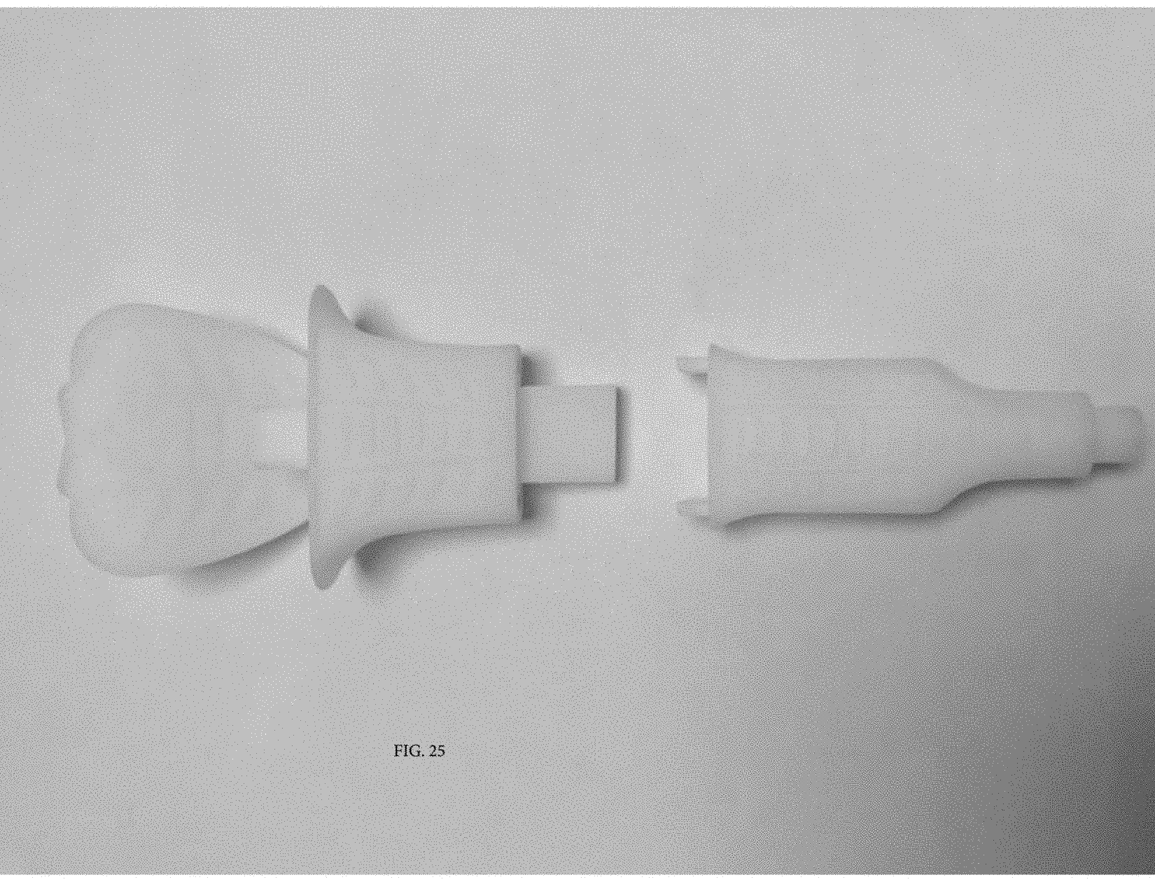

### SUMMARY OF THE INVENTION

The present invention is a multifunctioning device used to securely dock and simultaneously charge an electronic device. The present device includes a first end having a docking head and a second end having a USB connection, or other like means for receiving power. Preferably, the ends are connected by a military grade aluminum cable. The cable is flexible in order to provide the device the ability to function as an adjustable stand or docking station. The cable can be manipulated and twisted to adjust positioning of the electronic device as necessary in a plurality of positions for convenient and comfortable viewing. Preferably, the cable is approximately 2.5 feet and compatible with Apple® devices, Android® devices, and all other commercially available electronic devices.

The docking head is uniquely shaped to provide power to the electronic device while also securing fastening the device in an elevated position. The docking head includes a connection which is capable or charging Apple® devices, Android® devices, or devices utilizing a C-type connection. Preferably, the present device provides fast charging is approximately 2.4 amps. The docking head securely locks the electronic device in position.

In other embodiments, the docking head supports wireless, inductive, or cordless charging as a convenient and safe way to charge devices over traditional methods. Such embodiment could utilize electromagnetic field to transfer energy between two objects through electromagnetic induction. In the present application, wireless charging is done through the charging station, preferably contained within the docking head. Energy is sent through an inductive coupling to an electrical device, which can then use that energy to charge batteries or run the electronic device. In some embodiments, induction chargers use an induction coil to create alternating electromagnetic field from within the charging base, namely the docking head, and a second induction coil in the portable device takes power from the electromagnetic field and converts it back into electric current to charge the battery. The two induction coils in proximity combine to form an electrical transformer. A greater distance between the sender and receiver coils is also contemplated when the present invention utilizes resonant inductive coupling. In some embodiments, the resonant system includes using a movable transmission coil (i.e. mounted on an elevating platform or arm, in the present invention the docking head) and the use of other materials for the receiver coil made of silver plated copper or in some embodiments aluminum to minimize weight and decrease resistance due to the skin effect. In some embodiments other methods of wireless charging are contemplated. In some embodiments other means for containing the coils are present and the charging station may be contained in other components of the device.

The present invention provides hands free and easy to use docking and charging, supports both lightening and micro connections, is sturdy, durable and long lasting, is flexible and can rotate 360 degrees, and provides both horizontal and vertical viewing of the electronic device.

In an alternate embodiment, the docking head may include one or more stabilizing members in order to provide a more secure connection and eliminate wiggling. Preferably, the docking head and stabilizing member couple together via a male female connection. Preferably, the stabilizing member includes one or more male supports, while the docking head includes one or more matching female support. The male supports or the stabilizing member interlock with the female supports of the docking head to fully stabilize the docking head. In other embodiments, the male and female connections may be reversed for various design and aesthetic purposes.

It is to be understood that the disclosure teaches just some examples of the illustrative embodiment and that many variations of the invention can easily be devised by those skilled in the art after reading this disclosure.

We claim:

1. A new charger comprising:
a. A flexible gooseneck cable having a first end and a second end and containing within it a conductor, which is a means of conducting electronic power, running the length of said cable from said first end to said second end so that said conductor also has a first end and a second end and said conductor is capable of conducting power from its first end to its second end; wherein the first end of said conductor is essentially located at the first end of the cable and wherein the second end of said conductor is essentially located at the second end of said cable;
b. At the first end of said cable is a means of receiving electronic power from a power source; wherein said means of receiving power is coupled to the first end of the conductor so that electronic power can be conducted from the power source, through the conductor to the second end of the conductor;
c. At the second end of said cable is a docking head which comprises a stabilizing means capable of supporting and stabilizing an electronic device; and a charging means capable of charging an electronic device wherein said charging means is coupled to the second end of the conductor such that power received from the power source can be conducted through the charging means to an electronic device.

2. The Charger of claim 1 wherein the means of receiving electronic power is a plug capable of being plugged into a wall outlet, a USB plug capable of being plugged in a power source which supports a USB plug, or a car lighter plug capable of being plugged into a car lighter.

3. The Charger of claim 1 wherein the charging means can be adapted to interface with various electronic devices such as those utilizing USB, mini USB, micro USB and lightning ports.

4. The charger of claim 1 wherein the charging means can be adapted to provide charging through inductive wireless technology such as through electromagnetic induction.

5. The Charger of claim 1 wherein the charging means and the stabilizing means is a single element such as, but limited to USB, micro USB, mini USB, and lightning connectors capable of supporting an electronic device.

6. The Charger of claim 1 wherein the stabilizing means is separate from the charging means.

7. The Charger of claim 1 wherein the stabilizing means is configurable to support electronic devices of varying shapes and sizes.
